(19) United States
(12) Patent Application Publication
(10) Pub. No.: US 2005/0051685 A1
(43) Pub. Date: Mar. 10, 2005

(54) Pedestal assembly for computer enclosure

(76) Inventor: Pin-Shian Wu, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/936,258

(22) Filed: Sep. 7, 2004

(30) Foreign Application Priority Data
Sep. 5, 2003 (TW) 92216120

(51) Int. Cl. F16M 11/20; A47B 91/00

(52) U.S. Cl. 248/188.8; 248/346.01

(57) ABSTRACT

A pedestal assembly for a computer enclosure (50) includes two clenching parts (20). Each clenching part includes a body (30) and a fixing member (40). The body includes a head portion (32) with a number of gear teeth (38) projecting therefrom, and a supporting portion (36) extending from the head portion. The head portion defines a through hole (34) therein, for pivotably engaging the fixing member. The fixing member is fixedly secured to a bottom wall of the computer enclosure. The gear teeth of the clenching parts clench each other. Moving the supporting portion of one of the clenching parts will actuate the supporting portion of the other of the clenching parts to rotate around the other corresponding fixing member.

### BACKGROUND OF THE INVENTION

1. Field of the invention

The present invention relates to a supporting apparatus for computer enclosures, and particularly to a pedestal assembly which provides steady supporting means for computer enclosures.

2. Description of the related art

Conventional desktop computer enclosures are usually classified as tower computer enclosures and horizontal computer enclosures. Due to a compact size trend of the development of computer enclosures, horizontal computer enclosures are made much thinner than before. If a user wants to let his/her horizontal-type computer to stand like a tower-type computer, the positioning stability of the horizontal-type computer may be unqualified. It is requisite to provide a pedestal for supporting a horizontal-type computer when it is used like a tower-type computer.

U.S. patent application Ser. No. 6,364,278 discloses a pedestal designed to meet the above need. The pedestal includes a first supporting member and a second supporting member coupled together. The first supporting member includes a first base and a first ledge extending from the first base. The first base forms a first coupling wall and a first protrusion extending from the first coupling wall. A first recess is defined in the first base and exposed to the first coupling wall. The second supporting member includes a second base and a second ledge extending from the second base. The second base forms a second coupling wall for coupling to the first coupling wall and a second protrusion extending from the second coupling wall to be engagingly received in the first recess of the first supporting member. A second recess is defined in the base and exposed to the second coupling wall for engagingly receiving the first protrusion of the first supporting member. The second ledge is spaced from the first ledge to cooperatingly receive a computer enclosure therebetween.

The assembly of the first and second supporting members is simple. However, the first and second supporting members is not adjustable after being coupled, accommodating space therebetween suits only one single sized computer enclosure.

Chinese Patent Application No. 95211103.9 discloses a kind of adjustable pedestal, which includes a body and two supporting portions. A recess is formed respectively at opposite ends of the body, with a post respectively protruding therefrom. The supporting portions are pivotably secured to the body by the posts. The supporting portions accordingly can be adjusted freely according to different space required. However, each supporting portion must be adjusted separately and respectively, which is unduly cumbersome and time consuming.

Thus an improved pedestal assembly which overcomes the above-mentioned problems is desired.

### BRIEF SUMMARY OF THE INVENTION

Accordingly, an object of the present invention is to provide a pedestal assembly which provides steady and adjustable supporting means for computer enclosures.

To achieve the above-mentioned objects, a pedestal assembly for a computer enclosure comprises two clenching parts. Each clenching part comprises a body and a fixing member. The body comprises a head portion with a number of gear teeth projecting therefrom, and a supporting portion extending from the head portion. The head portion defines a through hole therein, for pivotably engaging the fixing member. The fixing member is fixedly secured to a bottom wall of the computer enclosure. The gear teeth of the clenching parts clench each other. Moving the supporting portion of one of the clenching parts will actuate the supporting portion of the other of the clenching parts to rotate around the other corresponding fixing member.

Other objects, advantages and novel features of the present invention will be drawn from the following detailed description of a preferred embodiment of the present invention with the attached drawings, in which:

### BRIEF DESCRIPTION OF THE DRAWINGS

FIG. 1 is an assembled view of a pair of pedestal assemblies in accordance with the preferred embodiment of the present invention, which is attached to a computer enclosure;

FIG. 2 is an exploded, isometric view of the pedestal of FIG. 1.

FIG. 3 is similar to FIG. 2, but viewed from another aspect;

FIG. 4 is an assembled view of FIG. 2;

FIG. 5 is an assembled view of FIG. 3;

FIG. 6 is an isometric view of the computer enclosure of FIG. 1;

FIG. 7 is a bottom view of FIG. 1;

FIG. 8 is similar to FIG. 7, but showing the pedestal assemblies are adjustable;

FIG. 9 is also similar to FIG. 7, but showing each of the pedestal is adjusted to an endmost position.

### DETAILED DESCRIPTION OF THE INVENTION

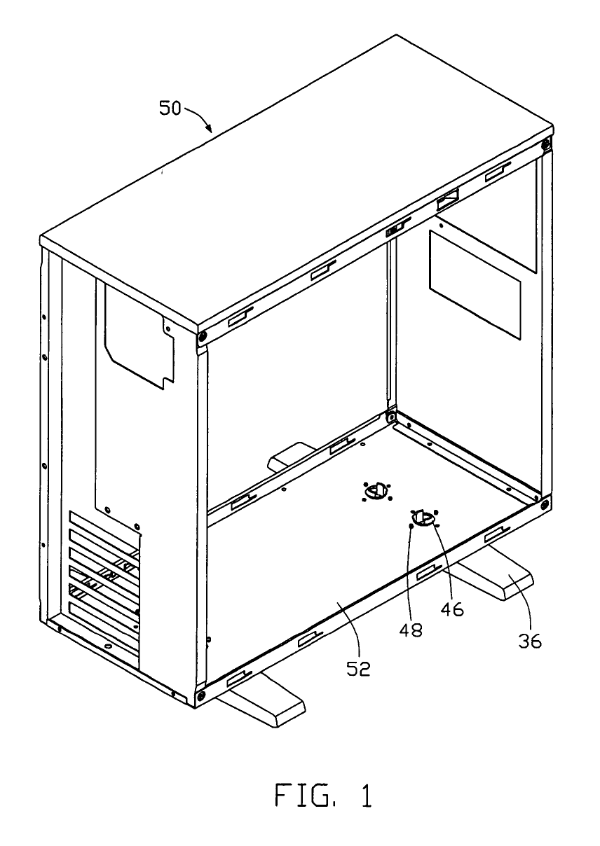

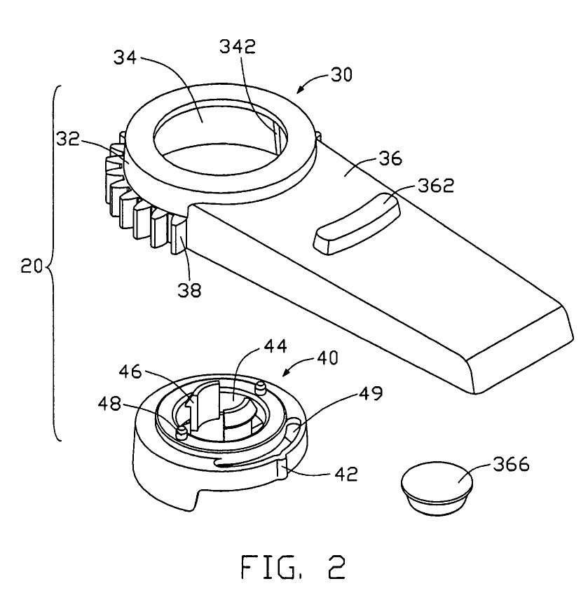

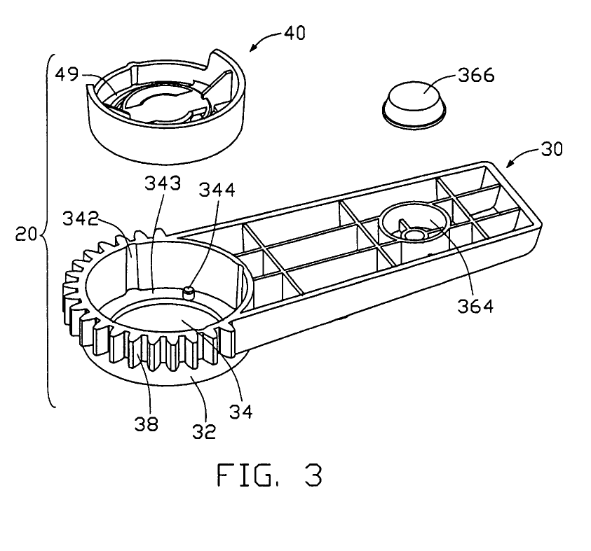

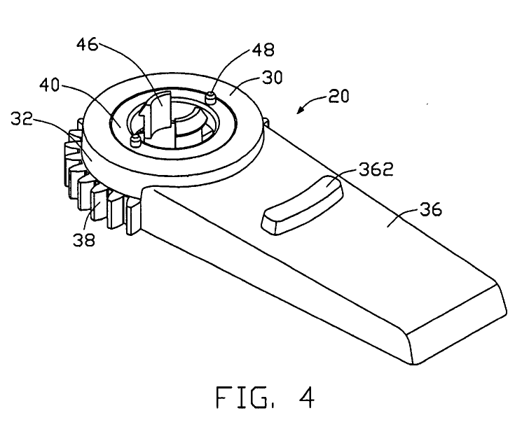

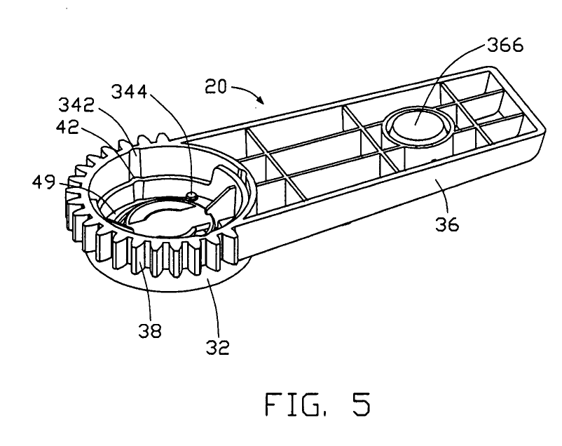

Referring to FIGS. 1-5, a pair of pedestal assemblies in accordance with the preferred embodiment of the present invention is used to support a computer enclosure 50. Each pedestal assembly comprises a pair of pedestals 20 which cooperatively engages with each other. Because the two pedestals 20 are substantially identical, only one of them will be described below.

The pedestal 20 comprises a body 30 and a fixing member 40 attached to the body 30. The body 30 comprises a cylindrical head portion 32, and a supporting portion 36 extending horizontally from an outer face of the head portion 32. The head portion 32 defines a through hole 34 therein. A pair of dents 342 is axially defined in a circumference of the through hole 34. A top portion of the head portion 32 bends inwardly toward the through hole 34 to form a flange 343, with a sliding post 344 protruding downwardly from a bottom face thereof. A plurality of spaced gear teeth 38 projects outwardly from a rest outer face of the head portion 32, for clenching its counterpart of the other pedestal 20. A protrusion 362 protrudes upwardly from a top portion of the supporting portion 36, for underlying the computer enclosure 50. A retaining cavity 364 is defined in a bottom portion of the supporting portion 36. A rubber pad 366 is interferentially accommodated in the cavity 364 for increasing frictions between the supporting portion 36 and a supporting plane contacting with the supporting portion 36.

The fixing member 40 is secured in the through hole 34 of the body 30. A rib 42 protrudes outwardly from an outer face of the fixing member 40, corresponding to the dents 342 of the body 30. A recess 44 is defined in a top portion of the fixing member 40. A pair of hooks 46 protrudes from a bottom face of the recess 44. Two opposite locating posts 48 are disposed on the fixing member 40 in a line perpendicular to the hooks 46. A curved sliding ditch 49 is defined in the fixing member 40 adjacent the rib 42, corresponding to the sliding post 344 of the body 30.

To assemble the pedestal 20, the fixing member 40 is engaged in the through hole 34 of the body 30 from a bottom thereof. Simultaneously, the sliding post 344 is slidably received in the sliding ditch 49, and the rib 42 is received in one of the dents 342. The sliding post 344 is slidable in the sliding ditch 49, thus the body 30 can be rotated about the fixing member 40.

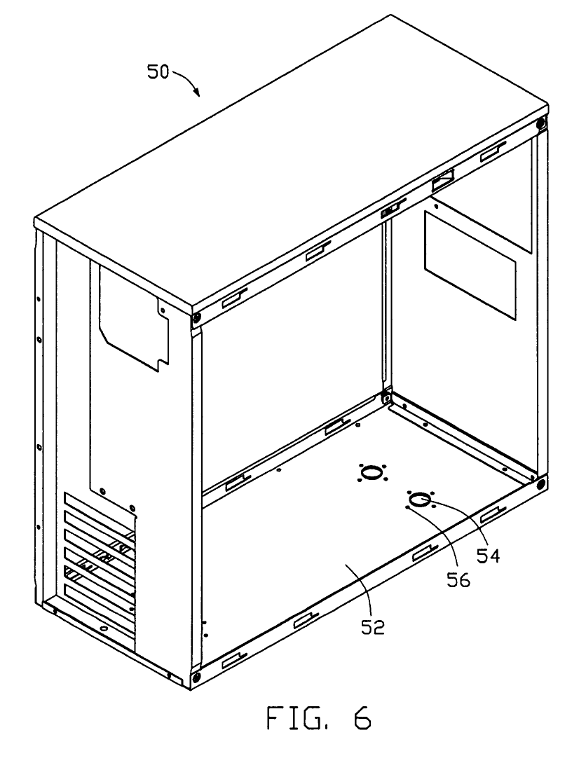

Referring also to FIG. 6, two pairs of locking holes 54 are defined in a bottom wall 52 of the computer enclosure 50, each corresponding to the hooks 46 of a corresponding fixing member 40. A plurality of locating holes 56 is defined around each locking hole 54, corresponding to the locating posts 48 of the fixing member 40.

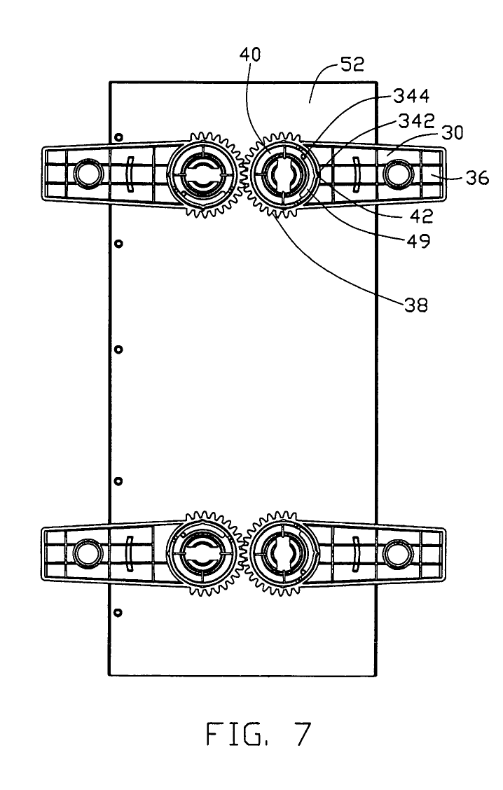

Referring also to FIG. 7, to attach the pedestals 20 to the bottom wall 52 of the computer enclosure 50, the hooks 46 of each pedestal 20 are snappingly engaged in the corresponding locking holes 54 of the bottom wall 52. Simultaneously, the locating posts 48 are interferentially inserted into the locating holes 56. Thus, the pedestals 20 are secured to the bottom wall 52. The pedestals 20 of each pedestal assembly are located symmetrically, with the gear teeth 38 of the pedestals 20 clenching each other. Moving one of the pedestals 20 will automatically actuate the other pedestal 20 of the same pair. When the pedestals 20 of each pedestal assembly are in alignment, that is, perpendicularly to sidewalls of the computer enclosure 50, the pedestal assembly supports the computer enclosure 50 best.

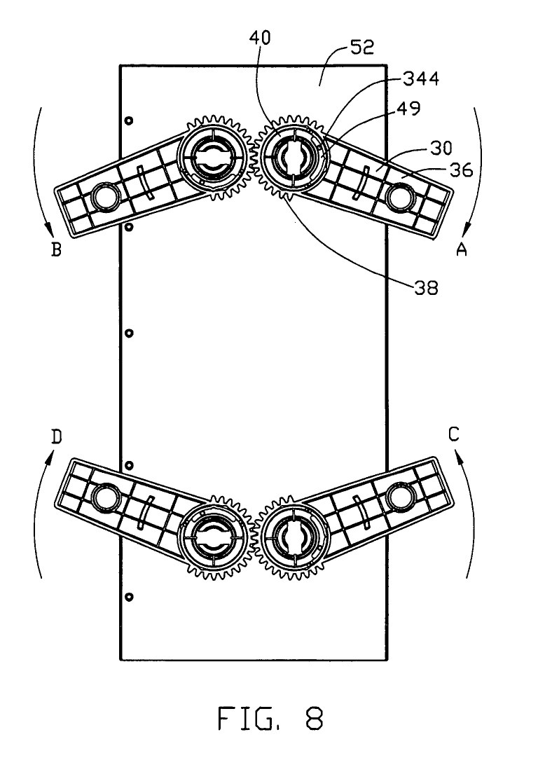

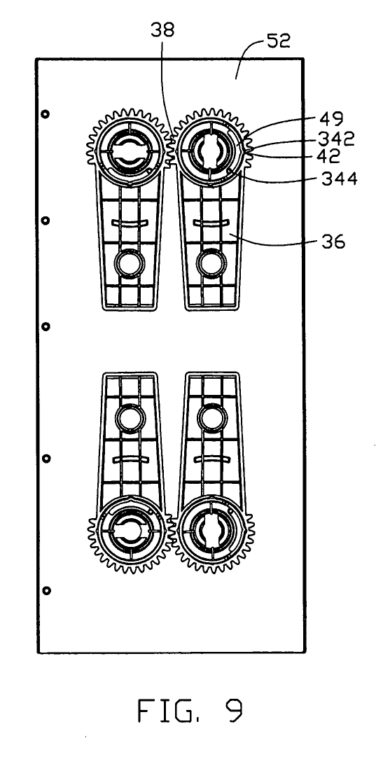

Referring to FIGS. 8 and 9, when the space for accommodating the computer enclosure 50 is limited, the supporting portion 36 of the pedestal assemblies can be adjusted between positions of perpendicular to and parallel with the sidewalls of the computer enclosure 50. The supporting portions 36 are rotated around the corresponding fixing members 40, respectively in directions A, B, C and D. Thus, a lot of space is saved.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A pedestal assembly for a computer enclosure comprising:
two clenching parts, each of the clenching parts comprising a body and a fixing member, the body comprising a head portion and a supporting portion extending from the head portion, a plurality of gear teeth projecting from the head portion, the head portion defining a through hole therein, for pivotably eagaging the fixing member, the fixing member adapted to be secured in a bottom wall of the computer enclosure;
wherein the gear teeth of the clenching parts clench each other, moving the supporting portion of one of the clenching parts will actuate the supporting portion of the other of the clenching parts to rotate around the other corresponding fixing member.

2. The pedestal assembly in accordance with claim 1, wherein a recess is defined in a top portion of the fixing member, and at least a pair of hooks protrudes from a bottom face of the recess for engaging with the computer enclosure.

3. The pedestal assembly in accordance with claim 1, wherein at least two locating posts are disposed on the fixing member for engaging with the computer enclosure.

4. The pedestal assembly in accordance with claim 1, wherein the head portion of the body is cylindrical, and a pair of dents is axially defined in a circumference of the through hole.

5. The pedestal assembly in accordance with claim 4, wherein a rib protrudes outwardly from an outer face of the fixing member, corresponding to the dents of the head portion.

6. The pedestal assembly in accordance with claim 1, wherein a top portion of the head portion bends inwardly toward the through hole to form a flange, with a sliding post protruding downwardly from a bottom face thereof.

7. The pedestal assembly in accordance with claim 6, wherein a curved sliding ditch is defined in the fixing member, corresponding to the sliding post.

8. The pedestal assembly in accordance with claim 1, wherein a protrusion protrudes upwardly from a top portion of the supporting portion, for underlying the computer enclosure.

9. The pedestal assembly in accordance with claim 1, wherein a retaining cavity is defined in a bottom portion of the supporting portion, for interferentially accommodating a rubber pad therein.

10. An assembly comprising:
a computer enclosure comprising a bottom wall, at least one pair of locking holes defined in the bottom wall; and
at least a pedestal assembly comprising two clenching parts, each of the clenching parts comprising a body and a fixing member, the body comprising a head portion and a supporting portion extending from one side of a periphery of the head portion, a plurality of gear teeth projecting from the other side of the periphery of the head portion, a plurality of locking members protruding from the fixing member corresponding to the locking holes of the bottom wall, wherein the locking members of the fixing member unrotatably engage in a corresponding locking hole, therefore securing the fixing member to the bottom wall of the computer enclosure, the head portion defines a through hole therein, for pivotably eagaging the fixing member;
and wherein the gear teeth of the clenching parts clench each other, rotation of the supporting portion of one of the clenching parts actuates the supporting portion of the other of the clenching parts to rotate.

11. The pedestal assembly in accordance with claim 10, wherein the locking members comprise a pair of hooks.

12. The pedestal assembly in accordance with claim 10, wherein at least one locating post extends from the fixing member of each of the clenching parts, and engages in a locating hole of the bottom wall of the computer enclosure, for anti-rotation.

13. The pedestal assembly in accordance with claim 10, wherein the head portion is cylindrical, and a pair of dents is axially defined in a circumference of the through hole.

14. The pedestal assembly in accordance with claim 13, wherein a rib protrudes outwardly from an outer face of the fixing portion, corresponding to the dents of head portion.

15. The pedestal assembly in accordance with claim 10, wherein a top portion of the head portion bends inwardly to form a flange, with a sliding post protruding downwardly from a bottom face thereof.

16. The pedestal assembly in accordance with claim 15, wherein a curved sliding ditch is defined in the fixing member, corresponding to the sliding post.

17. The pedestal assembly in accordance with claim 10, wherein a protrusion protrudes upwardly from a top portion of the supporting portion, for underlying the computer enclosure.

18. The pedestal assembly in accordance with claim 10, wherein a retaining cavity is defined in a bottom portion of the supporting portion, for interferentially accommodating a rubber pad therein.

19. A computer enclosure assembly comprising:
a casing being essentially of a rectangular configuration with thereon larger and small faces perpendicular to each other;
at least one pair of clenching parts moveably mounted to an exterior surface of one of the small face;
each of said clenching parts defining an elongated body; wherein
said elongated body is located within a contour of said small face when said elongated body is moved to a retracted position for a non-vertical use, while said elongated body projects out of the contour of said small face for a vertical use when said elongated body is moved to an extended position.

20. The computer enclosure assembly in accordance with claim 19, wherein said pair of clenching parts move synchronically.

21. The computer enclosure assembly in accordance with claim 19, wherein said pair of clenching parts move in a mirror image manner.

22. The computer enclosure assembly in accordance with claim 19, wherein said pair of clenching parts move in rotation.

23. The computer enclosure assembly in accordance with claim 22, wherein a rotation axis of said rotation is perpendicular to said small face.

24. The computer enclosure assembly in accordance with claim 19, wherein in the extended position, the elongated body extends out of a long edge of said small face rather than a short edge thereof.
